(19) United States
(12) Patent Application Publication
(10) Pub. No.: US 2026/0012355 A1
(43) Pub. Date: Jan. 8, 2026

(54) ELECTRONIC DEVICE AND METHOD FOR PARALLEL COMPUTATION IN CRYPTOGRAPHIC ALGORITHM

(71) Applicant: SAMSUNG ELECTRONICS CO., LTD., SUWON-SI (KR)

(72) Inventors: JONGYEON PARK, Suwon-si (KR); Dongsoo Lee, Suwon-si (KR)

(21) Appl. No.: 19/238,594

(22) Filed: Jun. 16, 2025

(30) Foreign Application Priority Data
Jul. 3, 2024 (KR) 10-2024-0087535

(51) Int. Cl. H04L 9/32; H04L 9/08

(52) U.S. Cl. CPC H04L 9/3247; H04L 9/0825; H04L 9/3239

(57) ABSTRACT

An electronic device for generating an electronic signature includes a plurality of processors and at least one memory. The memory stores a first element derived from a private key corresponding to a message. The device is configured to generate a hash value by applying a hash function to a seed decoded from the private key. It performs an initial sampling to extract a second element from a sample matrix based on the hash value and generates a multiplication matrix through iterative parallel operations. The first parallel operation includes the first processor outputting the hash value and the second processor multiplying the first element and the second element to generate a multiplication result. The second parallel operation includes the first processor sampling additional second elements and the second processor performing a cumulative summation operation on the multiplication result. After validating the multiplication matrix, the device generates the electronic signature.

### CROSS-REFERENCE TO RELATED APPLICATION(S)

This U.S. non-provisional application claims priority under 35 USC § 119 to Korean Patent Application No. 10-2024-0087535, filed on Jul. 3, 2024, in the Korean Intellectual Property Office, the disclosure of which is incorporated by reference in its entirety herein.

### 1. TECHNICAL FIELD

Example embodiments are directed to an electronic device and a method for parallel computation in a cryptographic algorithm.

### 2. DISCUSSION OF RELATED ART

A digital signature is a cryptographic technique used to ensure the integrity, authenticity, and non-repudiation of digital data. It is analogous to a handwritten signature or a seal in the physical world but is more secure because it relies on public-key cryptography.

Each user has a private key (kept secret) and a corresponding public key (shared with others). The data to be signed is first passed through a cryptographic hash function to produce a fixed-size hash (a unique “fingerprint” of the data). The hash is encrypted using the signer's private key, producing the digital signature.

To verify, the signature is decrypted using the signer's public key, revealing the hash. The verifier independently computes the hash of the original data and compares it with the decrypted hash. If the hashes match, the signature is valid.

Digital signatures are used to detect unauthorized modifications to data, authenticate the identity of a signer, and verify to a third party that the signature was generated by an actual signer. Further, signers are unable to easily repudiate their signatures later.

However, a portion of data used in signing algorithms to generate a digital signature may be significantly large, requiring a significant amount of memory for storing corresponding data.

### SUMMARY

Example embodiments provide an electronic device and a method for parallel computation in a cryptographic algorithm.

According to an example embodiment, an electronic device for generating an electronic signature includes a plurality of processors and at least one memory connected to the plurality of processors to store a first element to derived from a private key corresponding to a message. The electronic device is configured to generate a hash value by applying a hash function to a seed decoded from the private key, perform an initial sampling to extract a second element from a sample matrix based on the hash value and generate a multiplication matrix. It generates the multiplication matrix by repeatedly performing: a first parallel operation that includes: a first processor outputting the hash value; and a second processor multiplying the first element and the second element to generate a multiplication result; and a second parallel operation that includes: the first processor performing sampling of additional second elements from the sample matrix using the output hash value; and the second processor performing a cumulative summation operation on the multiplication result output for each row of the sample matrix. The electronic device performs a validity check on the multiplication matrix and generates the electronic signature for the message based on the first element, the sampled second elements, and the multiplication matrix, upon successful completion of the validity check.

According to an example embodiment, a method of generating an electronic signature includes storing a first element derived from a private key corresponding to a message, generating a hash value by applying a hash function to a seed decoded from the private key, performing an initial sampling to extract a second element from a sample matrix based on the hash value, and generating a multiplication matrix. The matrix is generated by repeatedly performing a first parallel operation and a second parallel operation. The first parallel operation includes a first processor outputting the hash value and a second processor multiplying the first element and the second element to generate a multiplication result. The second parallel operation includes the first processor performing sampling of additional second elements from the sample matrix using the output hash value and the second processor performing a cumulative summation operation on the multiplication result output for each row of the sample matrix. The method further includes performing a validity check based on the multiplication matrix and generating the electronic signature for the message based on the first element, the sampled second elements and the multiplication matrix, upon successful completion of the validity check.

According to an example embodiment, an electronic device for generating an electronic signature includes a plurality of processors and at least one memory connected to the plurality of processors to store a first element derived from a private key corresponding to a message. The electronic device is configured to generate a hash value by applying a hash function to a seed decoded from the private key, sample a second element included in a sample matrix based on the hash value and generate a multiplication matrix. The multiplication matrix is generated by repeatedly performing a first parallel operation, a second parallel operation and a transition operation. The first parallel operation includes the first processor outputting the hash value and the second processor performing a multiplication operation of the first element and the second element to generate a multiplication result. The second parallel operation includes the first processor sampling additional second elements from the sample matrix and the second processor performing a cumulative summation operation on the multiplication result for each row of the sample matrix. The transition operation includes writing the multiplication result or a result of the cumulative summation operation from one memory to another of the at least one memory. The electronic device performs a validity check on the multiplication matrix and generates the electronic signature for the message based on the first element, the sampled second elements and the multiplication matrix, upon successful completion of the validity check.

### BRIEF DESCRIPTION OF DRAWINGS

FIG. 1 is a diagram illustrating an electronic device according to example embodiments.

FIG. 2 is a flowchart illustrating an exemplary operation of a signature algorithm.

FIG. 3 is a diagram illustrating a hash value generation operation of an electronic device of FIG. 2 according to an example embodiment.

FIG. 4 is a diagram illustrating a sampling operation of the electronic device of FIG. 2 according to an example embodiment.

FIG. 5 is a diagram illustrating an example of a matrix operation according to FIG. 4.

FIG. 6 is a diagram illustrating a first parallel operation of the electronic device of FIG. 2 according to an example embodiment.

FIG. 7 is a diagram illustrating a second parallel operation of the electronic device of FIG. 2 according to an example embodiment.

FIG. 8 is a diagram illustrating an example of a matrix operation according to FIG. 7.

FIG. 9 is a diagram illustrating a first parallel operation of the electronic device of FIG. 2 according to an exemplary embodiment.

FIG. 10 is a diagram illustrating a second parallel operation of the electronic device of FIG. 2 according to an example embodiment.

FIG. 11 is a diagram illustrating an example of a matrix operation according to FIG. 10.

FIGS. 12 and 13 are diagrams illustrating multiplication matrices according to an example embodiment.

FIG. 14 is a flowchart illustrating an operation method of an electronic device according to an example embodiment.

FIG. 15 is a flowchart illustrating a parallel operation method of an electronic device according to an example embodiment.

FIG. 16 is a diagram illustrating an electronic device according to an example embodiment.

FIGS. 17 to 19 are diagrams illustrating operation methods of the electronic device of FIG. 16 according to an example embodiment.

FIG. 20 illustrates an operation method of the electronic device of FIG. 16 according to an exemplary embodiment.

FIG. 21 is a diagram illustrating an electronic device according to an example embodiment.

FIGS. 22 to 24 are diagrams illustrating operation methods of the electronic device of FIG. 21 according to an example embodiment.

FIG. 25 is a diagram illustrating an electronic device according to an example embodiment.

### DETAILED DESCRIPTION

At least one embodiment to be described in further detail below provides an electronic device for generating a digital signature that includes multiple processors and a memory configured to work collaboratively. The device generates a hash value by applying a hash function to a seed decoded from a private key. Using this hash value, it performs an initial sampling to extract elements from a sample matrix and iteratively builds a multiplication matrix through two types of parallel operations: in the first, one processor generates the hash value while another multiplies sampled elements to produce a multiplication result; in the second, one processor samples additional elements using the hash value while another performs cumulative summation of the multiplication results row by row. The device validates the multiplication matrix and, upon successful validation, generates the digital signature using sampled elements, the multiplication matrix, and the private key-derived first element. By dividing the computational tasks across multiple processors and performing operations simultaneously, the system significantly reduces the time required to generate a digital signature. This approach leverages the strengths of different processors (e.g., CPUs for hashing and GPUs for multiplication), ensuring no single processor becomes a bottleneck. Tasks that could traditionally delay the process, such as hash value generation and cumulative summation, are executed in parallel with other operations. This approach reduces the overall latency of the signature generation process. Further, by iteratively updating the multiplication matrix and dynamically managing data in memory, the system avoids the need to store large matrices at once, saving memory space and simplifying hardware requirements. Cryptographic systems often require intensive computations that can become a bottleneck in real-world applications. The approach described accelerates these computations, making it suitable for secure, real-time operations such as digital transactions, authentication, or secure communications.

Hereinafter, example embodiments will be described with reference to the accompanying drawings.

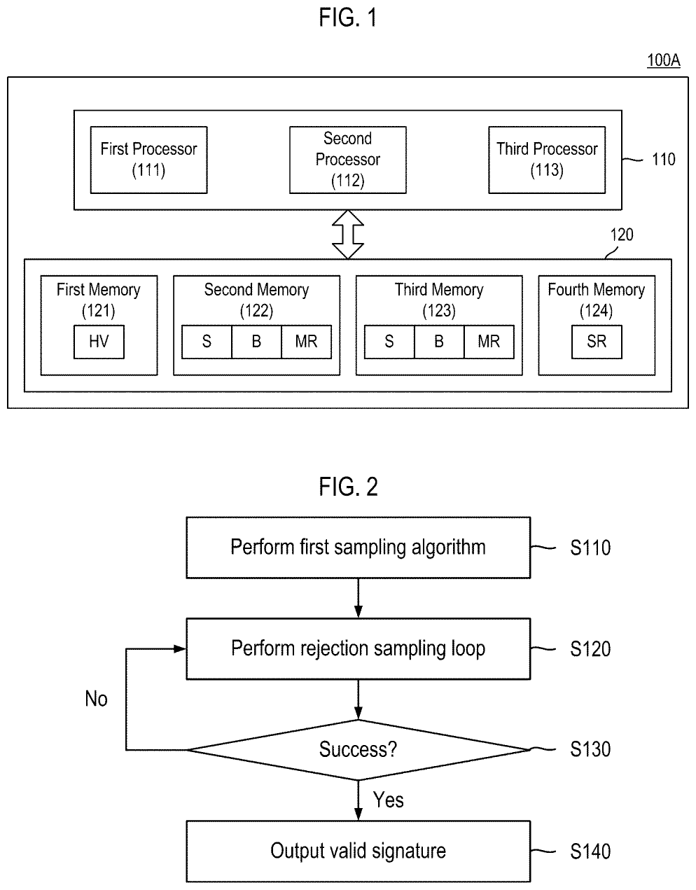

FIG. 1 is a diagram illustrating an electronic device according to an example embodiment, and FIG. 2 is a flowchart illustrating an exemplary operation of a signature algorithm.

Referring to FIG. 1, an electronic device 100A according to example embodiment includes one or more processors 110 and one or more memories 120. The electronic device 100A may perform a signature algorithm on data through the one or more processors 110 and the one or more memories 120.

The one or more memories 120 may store data required for the signature algorithm and data generated through the signature algorithm. The one or more processors 110 may access the one or more memories 120 to read stored data and perform the signature algorithm based on the read data. Alternatively, the one or more processors 110 may write data generated during the signature algorithm process to the one or more memories 120. Alternatively, the one or more processors 110 may read data stored in one of the one or more memories 120 and write the read data to another memory.

Referring to FIG. 2, the signature algorithm performed through FIG. 1 may include operations of outputting a valid signature. For example, the signature algorithm may be a module lattice-based digital signature algorithm (ML-DSA). The signature algorithm may generate a digital signature for data using a private key. The data may be hashed to generate a hash value and the hash value may be signed using the private key to generate a digital signature. For example, the hash value and the private key may be used as an input of the signature algorithm, and a signature may be output as an output of the signature algorithm.

The signature algorithm may additionally generate the signature using a seed. The seed may be a bit string used as an input of a pseudorandom operation. For example, the seed may be used to initialize a pseudorandom number generator. Variables used in the signature algorithm, such as the seed and a private value, may be generated by decoding the private key.

An example of the pseudorandom operation may be a first sampling algorithm. The first sampling algorithm may output a sample matrix based on a seed. The first sampling algorithm may be performed in operation S110.

The first sampling algorithm may input a seed to a hash function to generate a hash value. The hash function may be a function of a bit string with a fixed output length. For example, the hash function may process the seed that is a bit string and map this bit string to a fixed-size output bit string. The hash function may have the property that it is computationally infeasible to find an input mapped to a predefined arbitrary new output. For example, given a specific hash output, it is computationally infeasible to reverse-engineer or guess the input to the hash function that produces the corresponding output. Alternatively, a hash function may have the property that it is computationally infeasible to find two different inputs mapped to the same output. For example, if the hash function is applied to two different inputs, it is highly likely that the hash function will hash them to different values. An output of the hash function may be referred to as a hash value. A length of the hash value may vary depending on the implementation of the hash function. However, the length of the hash value is fixed when the same hash function is used.

For example, the hash function may be a secure hash algorithm KECCAK (SHAKE), SHAKE-256 or SHAKE-128, but is not limited thereto.

The first sampling algorithm may divide an output hash value into bit units (e.g., bits) or byte units (e.g., bytes), which may be referred to as hash units. The first sampling algorithm may compare each divided hash unit (e.g., a bit, a byte, etc.) with a set value based on at least one sampling condition. For example, the set value may be set to a prime number and may be variously set depending on the implementation of the signature generation algorithm.

For example, when a given hash unit is less than the set value, the first sampling algorithm may return a coefficient corresponding to the given hash unit. In the present application, a series of operations for returning a coefficient through the comparison between the hash value and the set value may also be referred to as “coefficient translation.” When a given hash unit is greater than or equal to the set value, the first sampling algorithm may return a blank symbol. The blank symbol refers to a failure or absence in an algorithm output. For example, the blank symbol may indicate that no output could be returned for the given hash unit.

In an embodiment, the coefficients, generated through the coefficient transformation, become individual elements of a sample matrix.

The signature algorithm may perform a second sampling algorithm through operation S120 to generate a polynomial vector “y” to disguise a private key of a signature algorithm. The second sampling operation may be a pseudorandom operation. In various embodiments, each element of the polynomial vector “y” for disguising a private key will be described as being generated and stored in memory in advance. Also, each element of the polynomial vector “y” may be referred to as a “first element” and each element of the sample matrix may be referred to as a “second element”. In an embodiment, the private key is incorporated into the polynomial vector “y”, which serves as a disguised representation of the key and the first element is derived from the polynomial vector “y”. This transformation makes the private key resistant to direct exposure or extraction during cryptographic computation. For example, there may be a transformation function that receives the private key and one or more parameters to generate the polynomial vector “y”.

The pseudorandom operation of the second sampling algorithm may use a seed and a value of a counter as an input. The seed may be different from the seed used in the first sampling algorithm. The counter may be a variable used in a rejection sampling loop.

The second sampling algorithm includes a rejection sampling loop, which iteratively generates and validates outputs such as signatures. Each iteration of the loop may generate a valid signature or an invalid signature. The loop continues until a valid signature is generated, relying on the second sampling algorithm to produce intermediate results for each iteration.

The polynomial vector “y” may be multiplied by the sample matrix generated through the first sampling algorithm to generate a multiplication matrix. The multiplication matrix may be referred to as a commitment vector. The commitment vector may be refined by applying a rounding operation.

The commitment vector may be converted into a commitment hash (e.g., a hash value) through a hash function.

The commitment hash may be used to generate a response of a signer, which is then subjected to a validity check. If the response fails the validity check, the rejection sampling loop may be repeated.

For example, the signature algorithm may perform the rejection sampling loop through operation S120 and determine whether the rejection sampling loop is successful through a validity check, through operation S130.

When the rejection sampling loop is successful and the validity check has completed, a hint polynomial vector “h” may be calculated from the rejection sampling loop. Finally, when the rejection sampling loop ends, the signature algorithm may generate a final signature based on the commitment hash, the response of the signer, and the hint polynomial vector “h” in operation S140.

In the above-described signature algorithm, generating the sample matrix may require a significantly prolonged computational operation. When rejection occurs in the rejection sampling loop, regeneration of the sample matrix may be required.

Returning to FIG. 1, the one or more processors 110 according to an example embodiment may be configured to implement the signature algorithm of FIG. 2. The one or more processors 110 may include a first processor 111, a second processor 112, and a third processor 113.

According to an example embodiment, the first processor 111 is configured to decode the private key to generate a seed and apply the seed to the above-mentioned hash function to generate a hash value HV The first processor 111 may output the hash value HV and write the hash value HV to the first memory 121.

The second processor 112 may be configured to perform the above-mentioned signature algorithm. The third processor 113 may perform various computational operations, required for the signature algorithm process, to assist the second processor 112.

For example, the second processor 112 may be a central processing unit (CPU), and the third processor 113 may be an accelerator such as a graphics processing unit (GPU). The third processor 113 may perform operations, such as multiplication and addition, required for the signature algorithm.

According to an example embodiment, the one or more memories 120 may include first to fourth memories 121 to 124. According to an example embodiment, each memory includes a single port. In the case in which each memory is implemented based on a single port, the implementation complexity may be reduced compared to the case in which each memory is implemented based on multiple ports. In an embodiment, only one of the one or more processors 110 is accessible to a single memory. Accordingly, each memory may be allocated to store specific data.

According to example embodiments, the first memory 121 stores a hash value HV. The second memory 122 and the third memory 123 may store a first element B (e.g., first data) and a second element S (e.g., second data), respectively. The second memory 122 and the third memory 123 may store not only the first element B and the second element S but also various types of data generated or processed through the signature algorithm. For example, the second memory 122 and the third memory 123 may store a hash value HV at which sampling is to be performed on the second memory 122 and the third memory 123, and may also store a multiplication result MR that is a result based on the multiplication operation. For example, the multiplication result MR may be generated by multiplying a row of the sample matrix by the polynomial vector “y”.

The fourth memory 124 may store a summation result SR from a cumulative summation operation. The cumulative summation operation may be performed to generate a multiplication matrix in the signature algorithm and may be defined as a cumulative sum of multiplication results MR output based on the multiplication operation for each row of a sample matrix.

According to an example embodiment, the second processor 112 may generate the sample matrix through the first sampling algorithm. The second processor 112 may output a signature by iteratively performing a rejection sampling loop that incorporates the second sampling algorithm. The second processor 112 may generate a polynomial vector “y” to disguise a private key of the signature algorithm through the second sampling algorithm. The second processor 112 may write the first element B, which is an individual element of the polynomial vector “y”, to the one or more memories 120.

According to an example embodiment, the second processor 112 samples the second element S included in the sample matrix based on the hash value HV. For example, the second processor 112 may select a certain second element S that corresponds to the hash value HV. The second processor 112 may perform a sampling condition check when the second element S is sampled. The sampling condition check is performed to determine whether the hash value HV is finally sampled as the second element S, based on a condition. The condition may be defined as whether the above-mentioned hash value HV (or a divided hash unit) is less than a specific value or a set value.

The second processor 112 may write the sampled second element S to the one or more memories 120.

The third processor 113 may be configured to access the second memory 122 or the third memory 123 to perform a multiplication operation and access the fourth memory 124 to perform a cumulative summation operation.

The third processor 113 may access one memory, in which the sampled second element S is stored, and perform a multiplication operation on the first element B and the second element S stored in a single memory. For example, an element S of the sample matrix may be multiplied by an element B of the polynomial vector “y” to generate a multiplication result MR. The multiplication result MR output based on the multiplication operation may be written in the fourth memory 124 through the second processor 112.

The third processor 113 may perform a cumulative summation operation on the multiplication result MR written in the fourth memory 124.

According to an example embodiment, the one or more processors 110 output a multiplication matrix through repetition of a first parallel operation and a second parallel operation. The first parallel operation may be defined as performing the multiplication operation of the first element B and the second element S and outputting the hash value HV in parallel. For example, the operation of outputting the hash value HV of the first processor 111 and the multiplication operation of the third processor 113 may be performed in parallel. For example, multiplication and hash outputs may happen together in the first parallel operation.

The second parallel operation may be defined as performing a cumulative summation operation of the multiplication result MR, output based on the multiplication operation for each row of the sample matrix, and a sampling operation in parallel. For example, the operation of sampling the hash value HV of the second processor 112 and the cumulative summation operation of the third processor 113 may be performed in parallel. For example, summations and sampling may happen together in the second parallel operation.

For example, the one or more processors 110 may generate a sample matrix partially, rather than at once. The second processor 112 may generate the hash value HV and sample the second element S through the first parallel operation and second parallel operation, and the third processor 113 may perform operations related to a multiplication matrix through the first parallel operation and the second parallel operation. The one or more processors 110 collaborate to generate the sample matrix and perform related computations, leveraging parallel operations for efficiency.

The second processor 112 may perform a validity check based on the multiplication matrix and output a signature based on a hash of the data upon successful validation.

According to the above-described embodiments, the electronic device 100A may perform sub-operations, required to generate the multiplication matrix required in the signature algorithm, in parallel. For example, the electronic device 100A may increase computational efficiency by performing operations necessary for generating a multiplication matrix (a multiplication operation and a cumulative summation operation) while partially generating a sample matrix, rather than generating the entire sample matrix at once. The increase in computational efficiency may reduce time required to regenerate the sample matrix when rejection occurs in the rejection sampling loop.

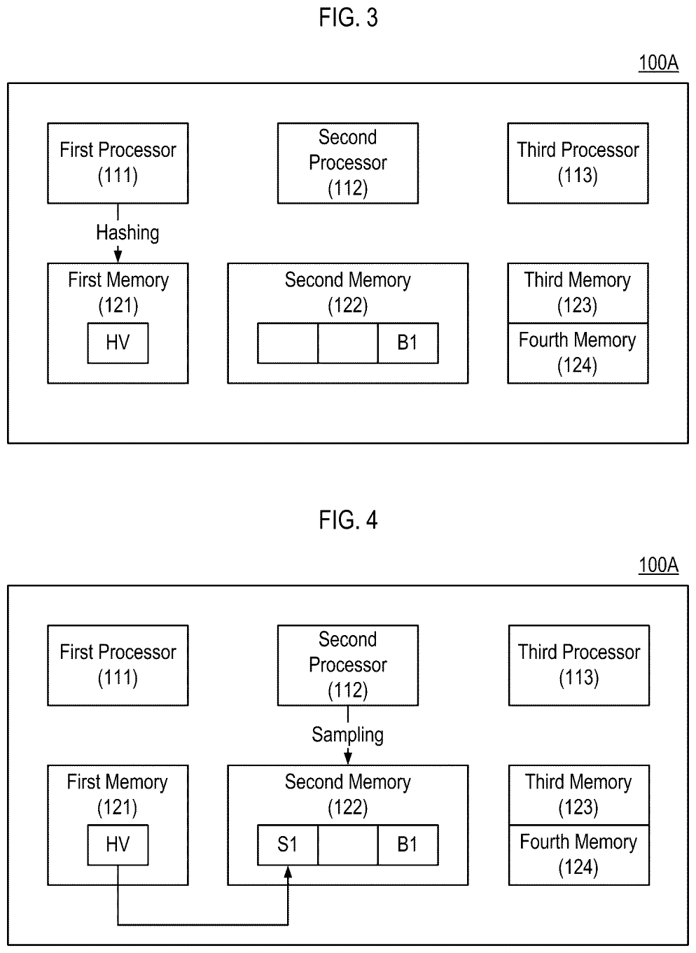

FIG. 3 is a diagram illustrating a hash value generation operation of an electronic device of FIG. 2 according to an example embodiment.

Referring to FIG. 3, in an initial stage, the electronic device 100A generates a hash value HV through the first processor 111 and writes the hash value HV in the first memory 121. For example, the first processor 111 may output a hash value HV by applying a hash function to a seed decoded from a private key. According to an example embodiment, the second processor 112 decodes the private key in advance to obtain the seed, and provides the seed to the first processor 111. The private key and the seed may be stored in at least one of the first memory to the fourth memory 121 to 124. Alternatively, at least one of the private key and the seed may be obtained from another electronic device, connected to the electronic device 100A.

The second memory 122 may store a first element B1. According to the above-described embodiments, the first element B1 may be generated and stored through the second sampling algorithm as an element of a polynomial vector for disguising the private key.

Generating the hash value HV through the first processor 111 may be iteratively performed to sample the second element. For example, the second element may be an individual element selected from the sample matrix. For example, the second element may be stored in the second memory 122. For example, the first processor 111 may generate a plurality of hash values HV to sample a single second element.

The current state is the initial state in which the second element has not been sampled, so that the second processor 112 and the third processor 113 may wait for sampling. The initial state may refer to the initial stage of the process where the second element has not yet been successfully sampled. At the beginning of the operation, no second element has been selected (or sampled) from the hash value generated by the first processor 111. The process of generating the hash value and evaluating it against sampling conditions is still ongoing. The second processor 112 and the third processor 113 may rely on the sampled second element for their respective tasks, such as performing multiplication operations or updating data structures like the multiplication matrix. Since the second element is a prerequisite for these operations, both the second and third processors 112 and 133 may remain idle or in a waiting state until the first processor 111 completes the sampling process.

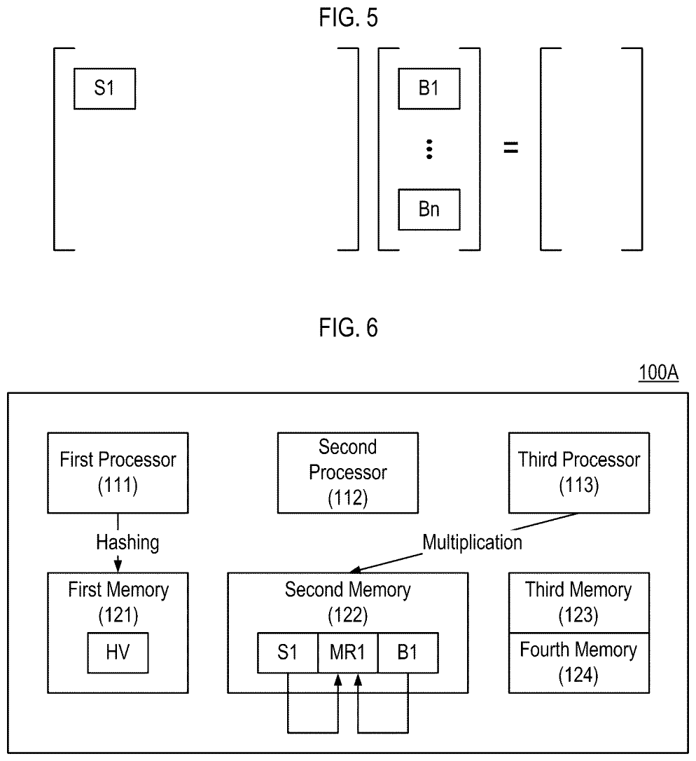

FIG. 4 is a diagram illustrating a sampling operation of the electronic device of FIG. 2 according to an example embodiment, and FIG. 5 is a diagram illustrating an example of a matrix operation according to FIG. 4.

Referring to FIG. 4, an electronic device 100A according to an example embodiment generates a hash value HV and writes the hash value HV to the first memory 121, and then performs sampling of a second element.

The second processor 112 may access the first memory 121 to perform sampling on the hash value HV. For example, the second processor 112 may retrieve the hash value HV stored in the first memory 121 to evaluate it and determine whether a valid selection element can be extracted from it. The evaluation may check specific units (e.g., bits or bytes) of the hash value HV to determine whether they satisfy a certain sampling condition. If the unit meets the condition, it is converted into a coefficient, which is then treated as the second element. When the sampling is successful, the second processor 112 may write the sampled second element S1 in the second memory 122. Alternatively, the second processor 112 may write the hash value HV, stored in the first memory 121, in the second memory 122 and access the second memory 122 to perform sampling on the hash value HV.

The second processor 112 may perform sampling through the first sampling algorithm according to the above-described embodiments. The first sampling algorithm may perform a sampling condition check to check the sampling condition.

The sampling condition check may be performed based on the hash value HV. For example, the second processor 112 may perform the sampling condition check based on dividing the hash value HV into specific hash units (e.g., bits or bytes) and determining whether the byte unit is less than a set value.

The second processor 112 may perform the sampling condition check based on the hash value HV and sample the second element S1 from the hash value HV based on success of the sampling condition check. For example, when the hash unit is less than the set value, the second processor 112 may determine that the sampling condition check is successful. When the hash unit is greater than or equal to the set value, the second processor 112 may determine that the sampling condition check has failed. When the sampling condition check fails, the sampling condition check may be repeatedly performed on a different hash value HV or a different hash unit.

For example, the second processor 112 may convert the hash unit into a coefficient based on the success of the sampling condition check, and sample the coefficient as the second element.

The second processor 112 may write the sampled second element S1 in the second memory 122 or the third memory 123. For example, in FIG. 4, the second processor 112 is illustrated as writing the first sampled second element S1 in the second memory 122, but example embodiments are not limited thereto.

The second memory 122 may store the pre-stored first element B1 and the sampled second element S1 together.

Referring to FIG. 5, the second elements corresponding to a first row and a first column has been generated in terms of a sample matrix, and the polynomial vector “y”, which is a matrix (or vector) of the first elements multiplied by the sample matrix, has already been generated. The matrix of first elements may be stored in advance in the second memory 122 and/or the third memory 123.

A multiplication matrix will be performed through the multiplication operation of the sample matrix and the polynomial vector “y”, and no element may be present at least at the time point of FIG. 4. For example, FIG. 4 may represent an early stage of computation where the system is still preparing the necessary inputs (second elements) for the multiplication operation.

FIG. 6 is a diagram illustrating a first parallel operation of the electronic device of FIG. 2 according to an example embodiment.

Referring to FIG. 6, the first parallel operation may be performed through the first processor 111 and the third processor 113. A multiplication operation of the first element and the second element and an operation of outputting a hash value HV may be performed in parallel through the first parallel operation.

The first processor 111 may output the hash value HV to the first memory 121 during the first parallel operation. For example, the first processor 111 may generate a hash value HV to sample a second element following the second element S1 sampled in FIGS. 4 and 5, and write the hash value HV in the first memory 121. For example, after sampling the second element as described in FIGS. 4 and 5, the first processor 111 may generate a new hash value HV to facilitate the sampling of the next second element and store the hash value HV in the first memory 121.

The third processor 113 may access the second memory 122 to perform a multiplication operation during the generation of the hash value HV. As illustrated in FIG. 6, when the second element is stored in the second memory 122, the second processor 112 may access the second memory 122 during the first parallel operation to perform a multiplication operation of the first element and the second element.

For example, the third processor 113 may multiply the first element B1 and the second element S1 stored in the second memory 122 to generate and output a multiplication result MR1. The multiplication result MR1 may be stored in the second memory 122.

The second processor 112 may wait for the generation of the hash value HV.

The first processor 111 and the third processor 113 may access different memories to perform the first parallel operation, resulting in increased computational efficiency even in a memory implemented with a single port.

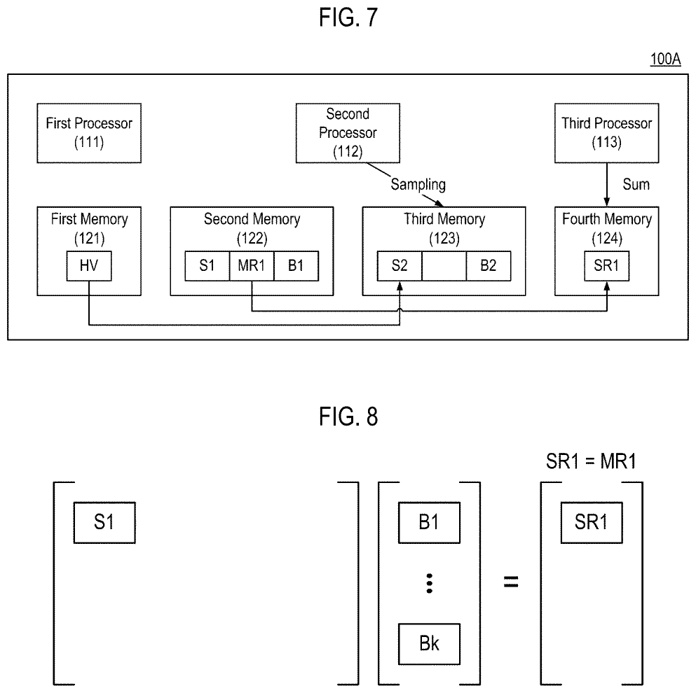

FIG. 7 is a diagram illustrating a second parallel operation of the electronic device of FIG. 2 according to an example embodiment, and FIG. 8 is a diagram illustrating an example of a matrix operation according to FIG. 7.

Referring to FIG. 7, the second parallel operation may be performed through the second processor 112 and the third processor 113. A cumulative summation operation of a multiplication result for each row of the sample matrix and a sampling operation may be performed in parallel through the second parallel operation.

For the second parallel operation, the second processor 112 may access the second memory 122 to write a multiplication result MR1 to the fourth memory 124, where it is treated as the first summation result SR1 after the cumulative summation operation.

The second processor 112 may access the third memory 123 to sample the second element S2 during the second parallel operation. For example, the second processor 112 may access the first memory 121 to perform sampling on the hash value HV. When the sampling is successful, the second processor 112 may write the sampled second element S2 in the third memory 123. Alternatively, the second processor 112 may write the hash value HV, stored in the first memory 121, in the third memory 123 and access the third memory 123 to perform sampling on the hash value HV.

The third memory 123 may store the first element B2.

The third processor 113 may access the fourth memory 124 to perform a cumulative summation operation. In the case of FIG. 7, only the multiplication result MR1 is present in the fourth memory 124, and thus may be accumulated.

The first processor 111 may wait for the completion of the second parallel operation, or may generate a hash value HV again when sampling has completed.

The second processor 112 and the third processor 11 may access different memories to perform the second parallel operation, resulting in increased computational efficiency even in a memory implemented with a single port.

Referring to FIG. 8, the first element of the multiplication matrix is a result of the cumulative summation operation on the first row of the sample matrix. As described above, a summation result SR1 may be the same as the multiplication result MR1. Also, as illustrated in the drawing, the sample matrix and the multiplication matrix may be partially generated during the execution of the signature algorithm, rather than all at once.

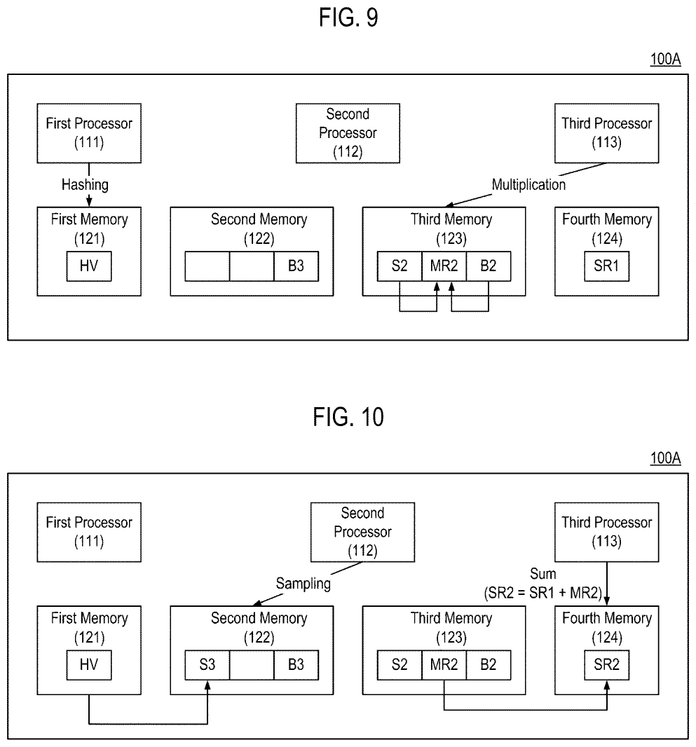

FIG. 9 is a diagram illustrating a first parallel operation of the electronic device of FIG. 2 according to an example embodiment.

Referring to FIG. 9, the first parallel operation may be performed again after the second parallel operation. For example, the first parallel operation and the second parallel operation may be alternately repeated. In an embodiment, a memory accessed for sampling is different from a memory accessed for a multiplication operation.

The first processor 111 may output a hash value HV to the first memory 121 during the first parallel operation. For example, the first processor 111 may generate a hash value HV to facilitate the sampling of the second element S3, which is illustrated in FIG. 10, and may write the hash value HV to the first memory 121.

The third processor 113 may access the third memory 123 to perform a multiplication operation during the generation of the hash value HV. This is because the second element S2 is stored in the third memory 123 through the embodiment of FIG. 7.

When the second element is stored in the third memory 123 as illustrated in FIG. 9, the second processor 112 may access the third memory 123 during the first parallel operation to perform a multiplication operation of the first element and the second element.

For example, the third processor 113 may multiply the first element B2 and the second element S2 stored in the third memory 123 to generate and output a multiplication result MR2 as a result of the multiplication. The multiplication result MR2 may be stored in the third memory 123.

The second processor 112 may wait for the generation of the hash value HV.

The second memory 122 may store a first element B3.

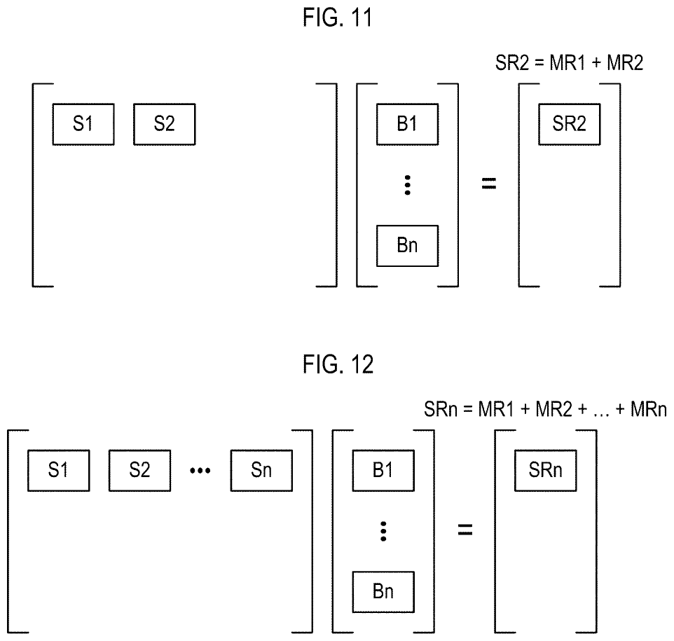

FIG. 10 is a diagram illustrating a second parallel operation of the electronic device of FIG. 2 according to an example embodiment, and FIG. 11 is a diagram illustrating an example of a matrix operation according to FIG. 10.

Referring to FIG. 10, during the second parallel operation, the second processor 112 may access the second memory 122 to sample the second element and the third processor 113 may access the fourth memory 124 to perform a cumulative summation operation.

For the second parallel operation, the second processor 112 may access the third memory 123 to write the multiplication result MR2 in the fourth memory 124. Subsequently, the third processor 113 may perform a cumulative summation operation, updating the fourth memory 124 to include the summation result SR2, as illustrated in FIG. 10.

The second processor 112 may access the second memory 122 to sample the third element S3 during the second parallel operation. For example, the second processor 112 may access the first memory 121 to perform sampling on a hash value HV. When the sampling is successful, the second processor 112 may write the sampled second element S3 in the second memory 122. Alternatively, the second processor 112 may write the hash value HV, stored in the first memory 121, in the second memory 122 and then access the second memory 122 to perform sampling on the hash value HV.

The third memory 123 may store a first element B3.

The third processor 113 may access the fourth memory 124 to perform a cumulative summation operation. In the case of FIG. 10, the cumulative summation operation begins with MR1 pre-stored in the fourth memory 124. After adding MR2, the summation result SR2 is stored in the fourth memory 124, as illustrated in FIG. 10. Therefore, the third processor 113 may perform a cumulative summation operation of adding the multiplication result MR2, generated as shown in FIG. 9, to the previously computed multiplication result MR1. The cumulative summation operation produces a summation result SR2, representing the sum of the multiplication results MR1 and MR2, which may be stored in the fourth memory 124.

The first processor 111 may wait for the completion of the second parallel operation or may generate a hash value HV again when sampling has completed.

Referring to FIG. 11, the first element of the multiplication matrix may be updated from SR1 to SR2 as a result of the cumulative summation operation, which adds the newly computed multiplication result to the previous summation. The first element of the multiplication matrix may be continuously updated as the cumulative summation operation is repeated according to the above-described embodiments.

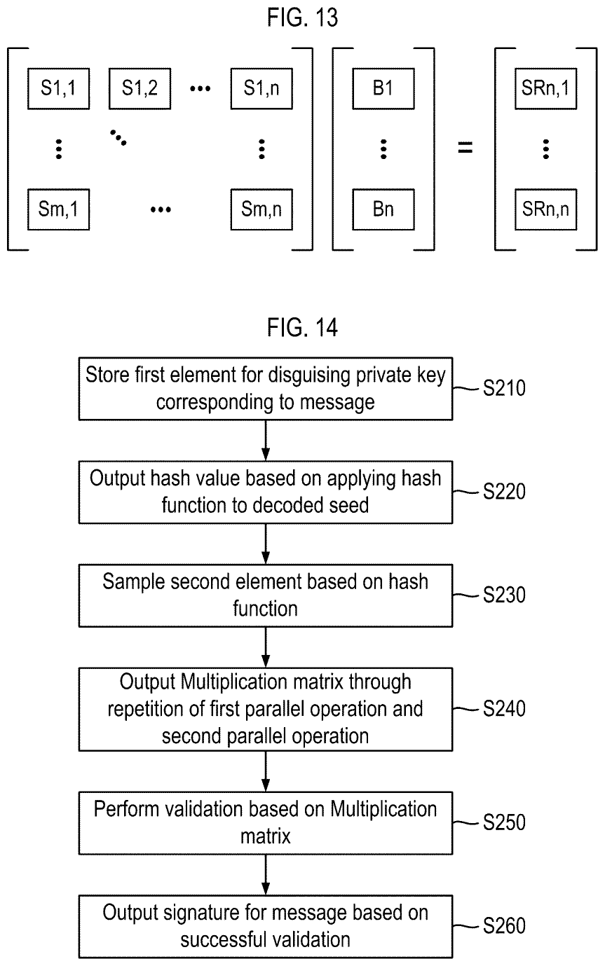

FIGS. 12 and 13 are diagrams illustrating multiplication matrices according to example embodiments.

Referring to FIG. 12, the first element of the multiplication matrix may be finally generated through the repetition of the first parallel operation and the second parallel operation.

The first element may be a result obtained by cumulatively summing multiplication results of each first element and each second element of the first row of the sample matrix. The first parallel operation and the second parallel operation may be repeated for each row of the sample matrix.

Referring to FIG. 13, an n-th element SRn,n of the multiplication matrix may be generated by cumulatively summing the multiplication results of n second elements and n first elements included in an m-th row of the sample matrix (where m is a positive integer).

FIG. 14 is a flowchart illustrating an operation method of an electronic device according to an example embodiment.

Referring to FIG. 14, in operation S210, the electronic device stores a first element for disguising a private key corresponding to a message in a second memory and a third memory. For example, the message may be the data or information for which a digital signature is being generated.

In operation S220, the electronic device outputs a hash value based on applying a hash function to a seed decoded from the private key. The private key may be created using a combination of random generation and machine learning. For example, the key may start as a random vector or matrix generated using a secure random number generator, and parameters from a trained machine learning model may be incorporated into the private key. In an embodiment, the seed is decoded from the private key by a deterministic extraction process, where the private key encapsulates information or transformations that can regenerate the seed.

In operation S230, the electronic device may sample a second element included in a sample matrix based on the hash value. For example, the electronic device may initialize the sample matrix and iteratively populate it by sampling second elements based on the hash value. For example, the electronic device may sample the second element from the hash value based on success of a sampling condition check.

In operation S240, the electronic device outputs a multiplication matrix through the repetition of a first parallel operation and a second parallel operation. A multiplication operation included in the first parallel operation may be performed based on access to a second memory or a third memory, and a cumulative summation operation included in the second parallel operation may be performed based on access to a fourth memory. For example, in the first parallel operation, a multiplication operation is performed, involving a first element (stored in either the second memory or the third memory) and a second element from the sample matrix; and the result of the multiplication is written back to memory as a multiplication result. For example, in the second parallel operation, a cumulative summation operation is carried out on the multiplication result to update the multiplication matrix; and this summation is performed by accessing the fourth memory, which stores intermediate results (such as SR1, SR2, etc.).

In operation S250, the electronic device may perform a validity check based on the multiplication matrix. For example, the electronic device may performs a validity check by evaluating the multiplication matrix against predefined criteria. These criteria may include verifying that all elements fall within a valid numeric range, ensuring consistency with input data, and checking structural properties. The electronic device may recompute or hash portions of the matrix to confirm its correctness. If the matrix satisfies all conditions, the process proceeds; otherwise, earlier steps are revisited to recompute the matrix.

In operation S260, the electronic device outputs a signature for the message when the validity check successfully validates the multiplication matrix. For example, the electronic device may generate the signature using the validated multiplication matrix.

According to an example embodiment, the method further includes an operation of writing the hash value, generated through operation S220, to the first memory included in the electronic device.

According to an example embodiment, the method further includes an operation of performing a sampling condition check based on the hash value.

According to an example embodiment, the method may further includes an operation of writing the second element in the second memory or the third memory included in the electronic device.

According to the above-described method, sub-operations required to generate a multiplication matrix required in a signature algorithm may be computed in parallel, so that computational efficiency may be increased.

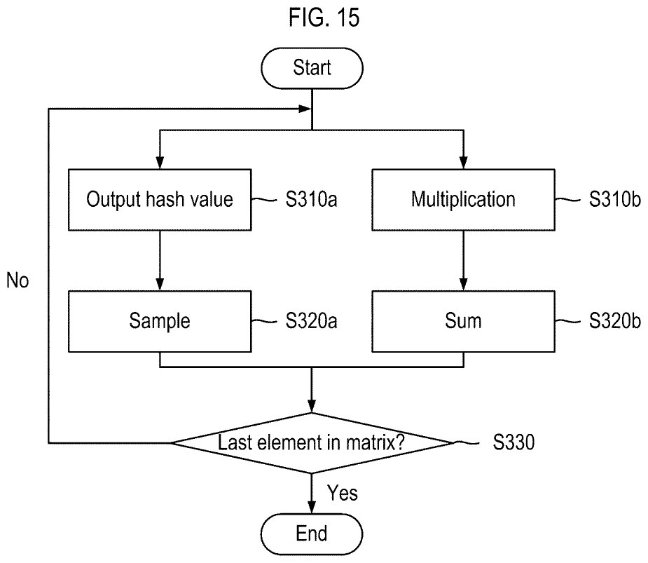

FIG. 15 is a flowchart illustrating a parallel operation method of an electronic device according to an example embodiment.

Referring to FIG. 15, a first parallel operation is performed through the parallel operations S310a and S310b. In operation S310a, the electronic device may output a hash value. In operation S310b, the electronic device may perform a multiplication operation on a single first element and a single second element. According to an example embodiment, operation S310a is repeated until a hash value is generated from which a valid single second element can be successfully sampled in operation S320a.

A second parallel operation may be performed through operations S320a and S320b. In operation S320a, the electronic device may perform sampling based on a hash value output through operation S310a. In operation S320b, the electronic device may perform a cumulative summation operation on a multiplication result output through operation S310b.

In operation S330, the electronic device may determine whether operations S310a, S310b, S320a, and S320b have been performed on a last element of the sample matrix. When operations S310a, S310b, S320a, and S320b have been performed on the last element, the electronic device may end the flow. When there are remaining elements, the electronic device may repeat operations S310a, S310b, S320a, and S320b. Also, operations S310a, S310b, S320a, and S320b may be performed for each row of the sample matrix.

According to the above-described embodiments, in terms of the entire first and second parallel operations, generation of a hash value with relatively low computational speed and sampling with relatively high computational speed may be sequentially performed, and a summation operation with relatively low computational speed and a multiplication operation with relatively high computational speed may be sequentially performed together. Accordingly, efficient computation may be performed in terms of the entire first and second parallel operations. These described enhancements in computation efficiency can significantly enhance the functioning of a computer, particularly in scenarios involving cryptographic algorithms, parallel operations, and resource-constrained environments.

Embodiments of the disclosure allow for efficient use of computational resources. By splitting operations into low-speed (e.g., hash value generation, summation) and high-speed tasks (e.g., sampling, multiplication) and performing them in parallel, the workload is distributed more effectively across processors. This ensures that no processor is idle unnecessarily, leading to better utilization of hardware resources.

Embodiments of the disclosure allow for reduced latency through parallelism. The first parallel operation combines low-speed hash value generation with high-speed multiplication, allowing both to progress simultaneously. The second parallel operation combines low-speed summation with high-speed sampling, again reducing idle time. This parallel execution reduces overall latency, as the tasks are not waiting for one another to complete sequentially.

Embodiments of the disclosure allow for improved throughput. By enabling multiple operations to proceed in parallel, the system can process more data in a given time frame, enhancing overall throughput. For example, in cryptographic applications, this could translate to faster digital signature generation or encryption.

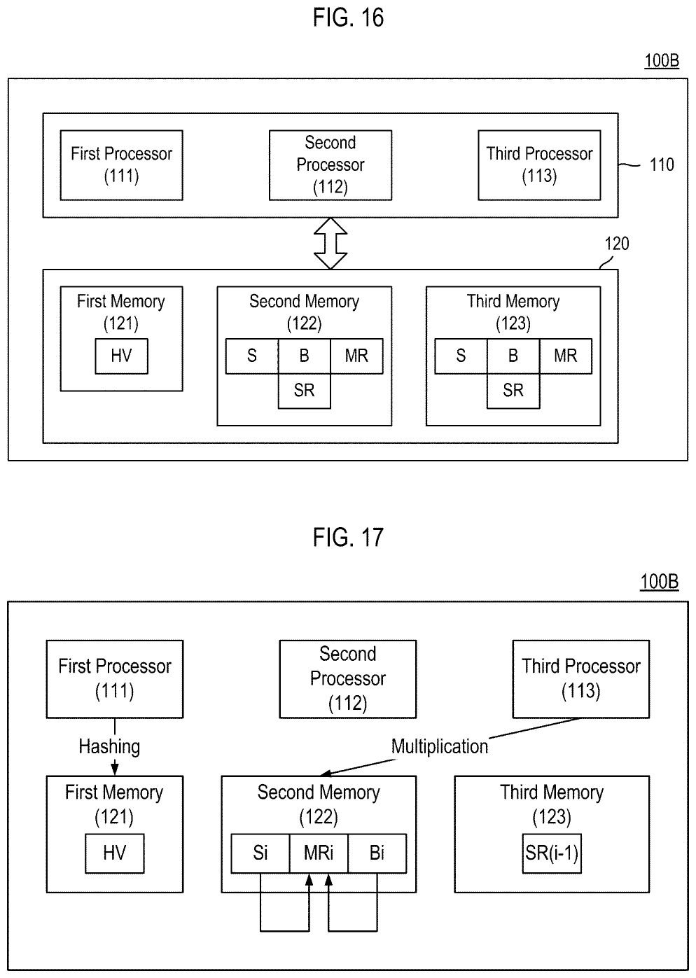

FIG. 16 is a diagram illustrating an electronic device according to an example embodiment.

Referring to FIG. 16, an electronic device 100B according to example an embodiment includes one or more processors 110 and one or more memories 120. Unlike FIG. 1, the electronic device 100B of FIG. 16 includes three memories.

The first memory 121 may store a hash value HV in the same manner. Unlike FIG. 1, the second memory 122 and the third memory 123 additionally store a summation result SR based on a cumulative summation operation in addition to a first element B, a second element S, and a multiplication result MR. For example, in the electronic device 100B of FIG. 1, storage of the summation result SR may be allocated to the second memory 122 or the third memory 123, instead of the fourth memory 124 storing the summation result SR, which allows the fourth memory 124 to be omitted.

According to an example embodiment, the first processor 111 outputs the hash value HV, and the third processor 113 performs a multiplication operation on the first element B and the second element S to generate a multiplication result MR.

The multiplication result MR based on the multiplication operation may be stored in one of the second memory 122 and the third memory 123, and the third processor 113 may access the one memory, in which the multiplication result MR is stored, to perform a cumulative summation operation. In parallel, the second processor 112 may access the other one of the second memory 122 and the third memory 123 to perform sampling of the second element S.

According to an example embodiment, a transition operation (or a write operation) may be additionally performed for a second parallel operation. The transition operation may be defined as writing the multiplication result MR or a result of the cumulative summation operation from one memory to another memory. The transition operation may be performed by the second processor 112 or the third processor 113.

When the multiplication result MR transitions (or is written) to the second memory 122, the cumulative summation operation may be performed in the second memory 122, and sampling may be performed in parallel in the third memory 123. Alternatively, when the multiplication result MR transitions (or is written) to the third memory 123, the cumulative summation operation may be performed in the third memory 123, and sampling may be performed in parallel in the second memory 122.

When the summation result SR transitions (or is written) to the second memory 122, the cumulative summation operation may be performed in the second memory 122, and sampling may be performed in parallel in the third memory 123. Alternatively, when the summation result SR transitions (or is written) to the third memory 123, the cumulative summation operation may be performed in the third memory 123, and sampling may be performed in parallel in the second memory 122.

The electronic device 100B may output a multiplication matrix through the repetition of the first parallel operation, the second parallel operation, and the transition operation according to the above-described embodiments.

The electronic device 100B according to the above-described embodiments may decrease the number of memories required for a signature algorithm operation of the electronic device 100B by omitting a memory storing the summation result SR.

FIGS. 17 to 19 are diagrams illustrating operation methods of the electronic device of FIG. 16 according to example embodiments.

Referring to FIG. 17, an example is provided in which a first element Bi (where i is a small natural number less than or equal to n) and a second element Si are stored in the second memory 122, and a summation result SR(i−1) is stored in the third memory 123. For example, unlike FIG. 17, according to example embodiments, the summation result SR(i−1) may be stored in the second memory 122, and the first element Bi and the second element Si may be stored. In addition, a memory accessed by each processor may be different.

The first processor 111 may generate and store a hash value HV in the first memory 121. In parallel, the third processor 113 may access the second memory 122 to perform a multiplication operation on the first element Bi and the second element Si to generate a multiplication result MRi, and the multiplication result MRi based on the multiplication operation may be stored in the second memory 122.

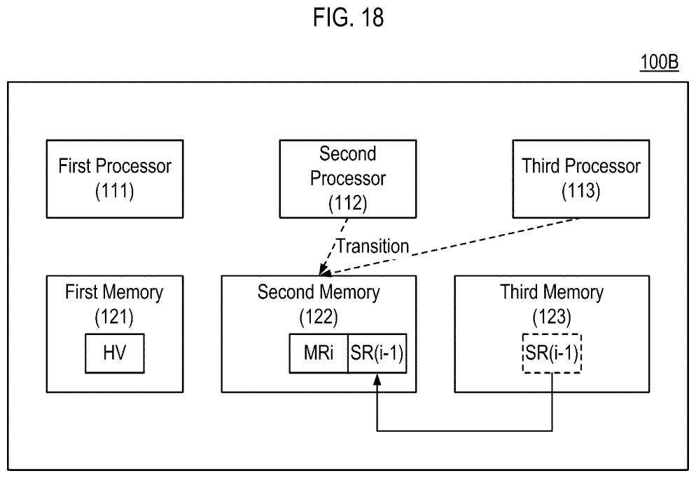

Referring to FIG. 18, the second processor 112 or the third processor 113 may transition (or write) the summation result SR(i−1), stored in the third memory 123, to the second memory 122 in which the multiplication result MRi is stored. When one processor performs a transition operation (e.g., a write operation), the other processors may wait. Alternatively, at least the first processor 111 may generate the hash value HV.

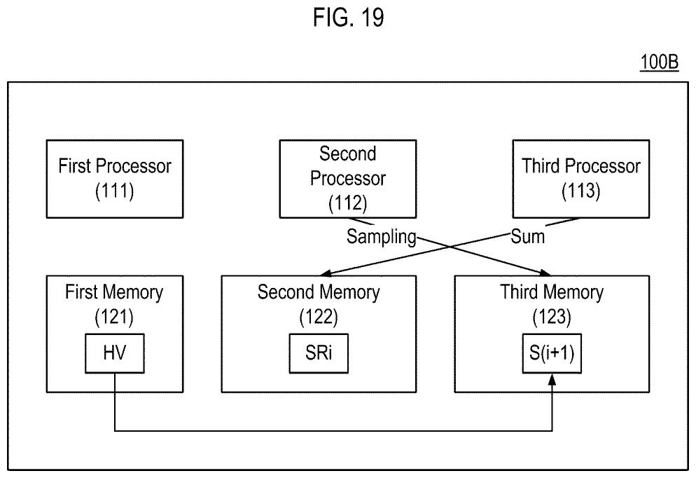

Referring to FIG. 19, the second processor 112 may perform sampling to write a second element Si+1 in the third memory 123. In parallel, the third processor 113 may access the second memory 122 to perform a cumulative summation operation. For example, the third processor 113 may sum the multiplication result MRi and the summation result SR(i−1), stored in the second memory 122 to generate a summation result SRi, and write the summation result SRi to the second memory 122.

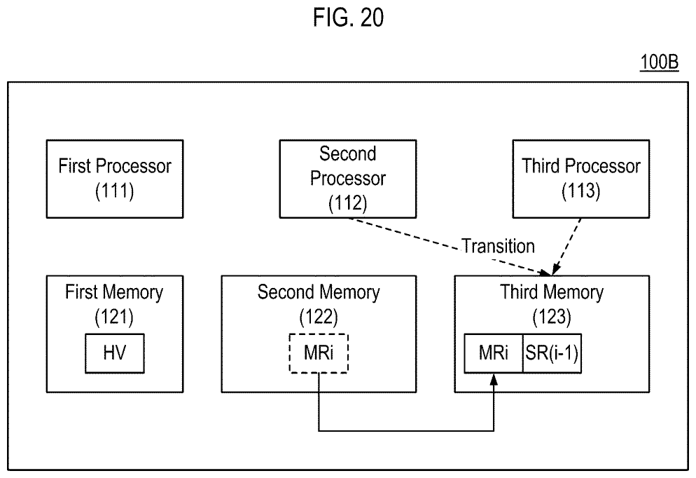

FIG. 20 is a diagram illustrating a method of operating the electronic device of FIG. 16 according to an example embodiment.

Referring to FIG. 20, unlike performing the transition operation on the summation result (see FIG. 18), the electronic device 100B according to example embodiments may also perform a transition operation on a multiplication result.

The second processor 112 or the third processor 113 may transition (or write) a multiplication result MRi, stored in the second memory 122, to the third memory 123 in which a summation result SR(i−1) is stored. When one processor performs the transition operation (or a write operation), the other processors may wait. Alternatively, at least the first processor 111 may generate a hash value HV.

Then, the second processor 112 may perform sampling to write the second element to the second memory 122, and the third memory 123 may access the third memory 123 to perform a cumulative summation operation.

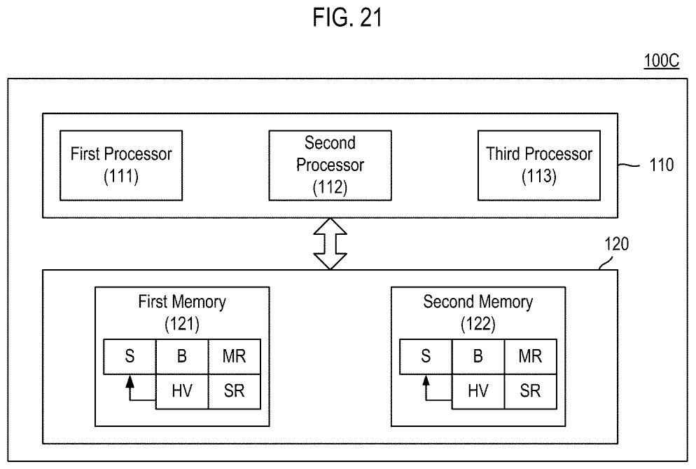

FIG. 21 is a diagram illustrating an electronic device according to an example embodiment.

Referring to FIG. 21, an electronic device 100C according to an example embodiment includes one or more processors 110 and one or more memories 120. Unlike FIG. 1, the electronic device 100C of FIG. 21 may include two memories.

The first memory 121 and the second memory 122 may store a hash value HV in addition to a first element B, a second element S, a multiplication result MR, and a summation result SR. For example, in the electronic device 100C of FIG. 1, storage of the hash value HV may be allocated to the first memory 121 and the second memory 122, so that a separate memory storing the hash value HV can be omitted.

According to example embodiments, the first processor 111 may output the hash value HV, and the third processor 113 may perform a multiplication operation on a first element B and a second element S.

The first processor 111 may write the generated hash value HV to one of the first memory 121 and the second memory 122. For example, the first processor 111 may write the hash value HV to a memory other than the memory used to store the data for the multiplication operation.

A multiplication result MR based on the multiplication operation may be stored in one of the first memory 121 and the second memory 122, and the third processor 113 may access the one memory, in which the multiplication result MR is stored, to perform a cumulative summation operation. In parallel, the second processor 112 may access the other one of the first memory 121 and the second memory 122 to perform sampling of the second element S.

According to an example embodiment, a transition operation (or write operation) may be additionally performed for the second parallel operation. The transition operation may be performed on a summation result SR.

When the summation result SR transitions (or is written) to the second memory 122, the cumulative summation operation may be performed on data in the second memory 122, while sampling may be performed in parallel using data in the first memory 121. Alternatively, when the summation result SR transitions (or is written) to the first memory 121, the cumulative summation operation may be performed in the first memory 121, and sampling may be performed in parallel in the second memory 122.

The electronic device 100C according to the above-described embodiments may output a multiplication matrix through repetition of the first parallel operation, the second parallel operation, and the transition operation.

The electronic device 100C according to the above-described embodiments may decrease the number of memories required for a signature algorithm operation of the electronic device 100C by omitting a memory storing a summation result SR.

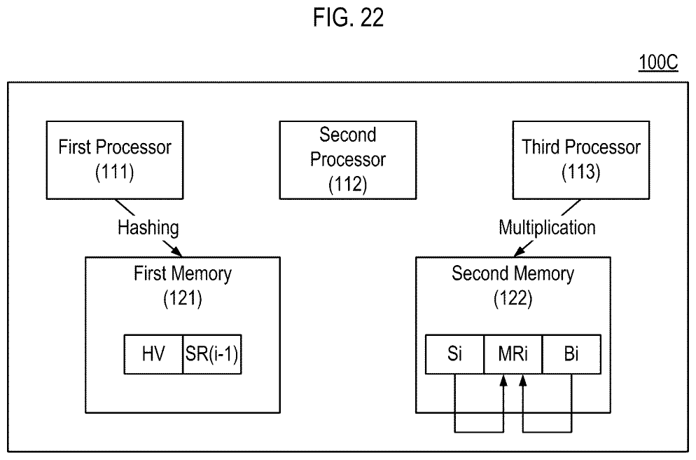

FIGS. 22 to 24 are diagrams illustrating operation methods of the electronic device of FIG. 21 according to example embodiments.

Referring to FIG. 22, an example is provided in which a first element Bi and a second element Si are stored in a second memory 122, and a summation result SR(i−1) is stored in a third memory 123.

The first processor 111 may generate and store a hash value HV in the first memory 121. In parallel, the third processor 113 may access the second memory 122 to perform a multiplication operation of a first element Bi and a second element Si for generating multiplication result MRi, and the multiplication result MRi based on the multiplication operation may be stored in the second memory 122. As illustrated, the first memory 121 may store both the hash value HV and the summation result SR(i−1).

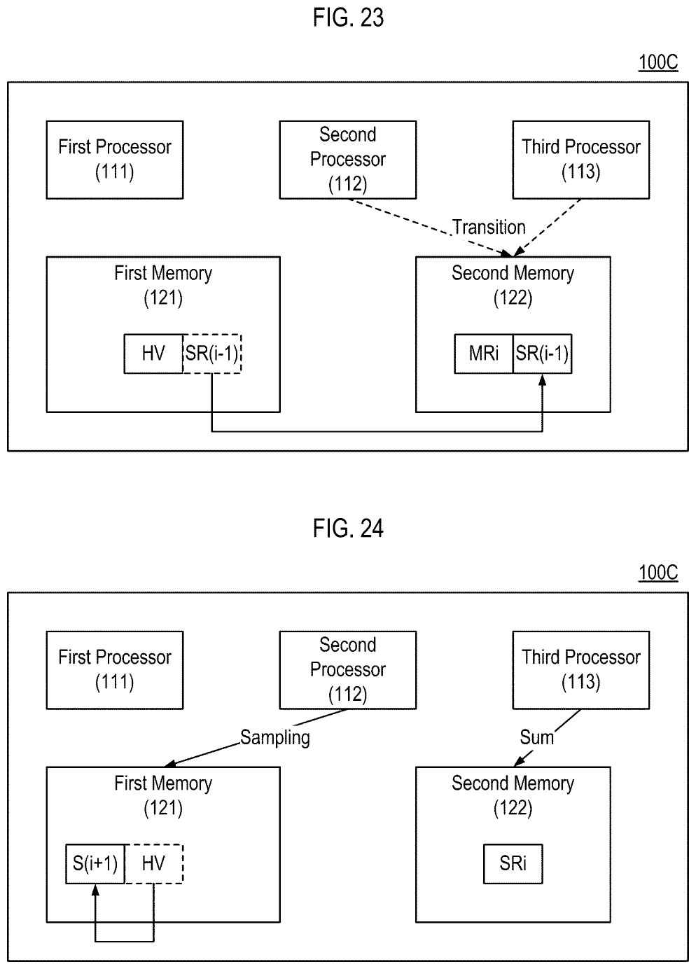

Referring to FIG. 23, the second processor 112 or the third processor 113 may transition (or write) the summation result SR(i−1), stored in the first memory 121, to the second memory 122 in which the multiplication result MRi is stored. When one processor performs the transition operation, the other processors may wait.

Referring to FIG. 24, the second processor 112 may perform sampling to write a second element S(i+1) in the first memory 121 in which the hash value HV is stored. In parallel, the third processor 113 may access the second memory 122 to perform a cumulative summation operation. For example, the third processor 113 may sum the multiplication result MRi and the summation result SR(i−1) stored in the second memory 122 to generate a summation result SRi and write the summation result SRi to the second memory 122.

Then, the electronic device 100C may output a multiplication matrix through repetition of the first parallel operation, the second parallel operation, and the transition operation according to the above-described embodiments. In FIG. 24, the first processor 111 may generate and write the hash value HV to the second memory 122, and the third processor 113 may multiply the second element S(i+1), stored in the first memory 121, with the first element.

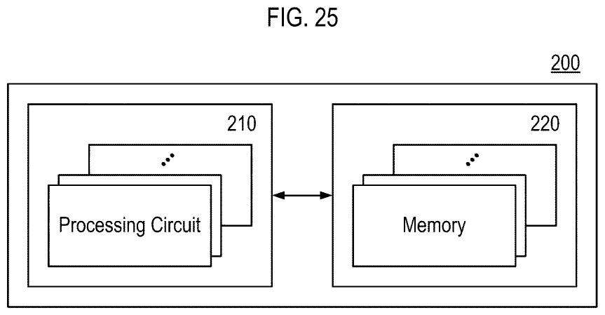

FIG. 25 is a diagram illustrating an electronic device according to an example embodiment.

Referring to FIG. 25, an electronic device 200 according to example embodiment includes one or more processors 210 and one or more memories 220.

The processor 210 may be connected to the memory 220 to control the memory 220 and may execute at least one instruction, stored in the memory 220, to implement the descriptions, functions, procedures, proposals, methods, and/or operational flowcharts of the present disclosure. In addition, the processor 210 may provide operations according to various embodiments based on instructions stored in the memory 220. In addition, the processor 210 may process information, stored in the memory 220, to generate data.

According to example embodiments, each processor 210 may be an additional processor, or may be a core included in a multi-core processor. A multi-core processor may be a single computing component including two or more independent processors, and each of the processors (or cores) may read and execute an instruction.

According to example embodiments, when the processor 210 is provided in plural or

implemented as a multi-core processor, the processor 210 may perform parallelization according to the above-described embodiments. For example, each of the plurality of processors 210 may perform shortest path calculation and betweenness centrality (BC) value calculation for a plurality of node groups.

According to example embodiments, the processor 210 may include one or more processing elements that may be symmetric or asymmetric. The processing element may refer to hardware or logic for supporting a software thread. For example, a hardware processing element may include a thread unit, a thread slot, a thread, a process unit, a context, a context unit, a logical processor, a hardware thread, and a core. For example, a processing element may refer to any hardware that may be independently associated with a software thread, an operating system, or an application, or other codes.

According to example embodiments, the processor 210 may be implemented as a general-purpose processor, a specific-purpose processor, or an application processor (AP). For example, the processor 210 may be a computing processor (for example, a CPU, a GPU, or the like) including a specific-purpose logic circuit (for example, a field programmable gate array (FPGA), an application specific integrated circuits (ASICs), or the like).

The memory 220 may be connected to the processor 210 and may store various types of information related to the operation of the processor 210. For example, the memory 220 may store software code including at least one instruction for performing some or all of the processes or threads controlled by the processor 210 or for performing the descriptions, functions, procedures, proposals, methods, and/or operational flowcharts of the present disclosure. For example, the software code may be implemented in a procedural or object-oriented programming language, or may be implemented in assembly language or machine language as necessary. Alternatively, the software code may be implemented in a declarative programming language. In addition, example embodiments are not limited to any specific programming language.

The processor 210 may execute at least one instruction, stored in the memory 220, to perform operations and functions according to the above-described embodiments of FIGS. 1 to 24. According to example embodiments, the processor 210 may output a hash value based on applying a hash function to a seed decoded from a private key, and sample a second element, included in a sample matrix, based on the hash value. The processor 210 may output a multiplication matrix through the repetition of a first parallel operation of performing a multiplication operation on the first element and a second element and outputting a hash value in parallel and a second parallel operation of performing a cumulative summation operation on an output multiplication result and performing sampling based on a multiplication operation for each row of the sample matrix in parallel, perform a validity check based on the multiplication matrix, and output a signature for a message based on the success of the validity check.

As set forth above, according to example embodiments, an electronic device and a method for parallel computation in a cryptographic algorithm.

While example embodiments have been shown and described above, it will be apparent to those skilled in the art that modifications and variations could be made without departing from the scope of the present inventive concept as defined by the appended claims.

What is claimed is:

1. An electronic device for generating an electronic signature, comprising:
a plurality of processors including a first processor and a second processor; and
at least one memory connected to the plurality of processors to store a first element derived from a private key corresponding to a message,
wherein the electronic device is configured to:
generate a hash value by applying a hash function to a seed decoded from the private key;
perform an initial sampling to extract a second element from a sample matrix based on the hash value;
generate a multiplication matrix by repeatedly performing:
a first parallel operation that includes:
the first processor outputting the hash value; and
the second processor multiplying the first element and the second element to generate a multiplication result; and
a second parallel operation that includes:
the first processor performing sampling of additional second elements from the sample matrix using the output hash value; and
the second processor performing a cumulative summation operation on the multiplication result output for each row of the sample matrix;
perform a validity check on the multiplication matrix; and
generate the electronic signature for the message based on the first element, the sampled second elements and the multiplication matrix, upon successful completion of the validity check.

2. The electronic device of claim 1, wherein the at least one memory comprises:
a first memory configured to store the hash value;
a second memory and a third memory, each configured to store at least one of the first element, the sampled second elements, or the multiplication result; and
a fourth memory configured to store a summation result based on the cumulative summation operation.

3. The electronic device of claim 2, wherein the plurality of processors further comprise a third processor,
wherein the first processor is configured to generate the hash value and write the hash value to the first memory,
wherein the second processor is configured to perform a sampling condition check based on the hash value, sample the additional second elements from the hash value based on success of the sampling condition check, and write the sampled second elements to the second memory or the third memory, and
wherein the third processor is configured to access the second memory or the third memory for multiplying the first element and one of the sampled second elements and access the fourth memory to perform the cumulative summation operation.

4. The electronic device of claim 3, wherein the second processor divides the hash value into specific byte units and performs the sampling condition check based on determining whether a corresponding one of the byte units is less than a set value.

5. The electronic device of claim 4, wherein the second processor determines that the sampling condition check is successful, based on the byte units being less than the set value.

6. The electronic device of claim 4, wherein the second processor converts a corresponding one of the byte units into a coefficient and samples the coefficient as one of the additional second elements, based on the success of the sampling condition check.

7. The electronic device of claim 3, wherein
the first processor outputs the hash value to the first memory during the first parallel operation, and
the third processor accesses the second memory during the first parallel operation to perform a multiplication operation of the first element and one of the sampled second elements and writes the multiplication result to the fourth memory, based on the one sampled second element being stored in the second memory.

8. The electronic device of claim 7, wherein the second processor accesses the third memory to sample the second element and the third processor accesses the fourth memory to perform the cumulative summation operation, during the second parallel operation.

9. The electronic device of claim 3, wherein
the first processor outputs the hash value to the first memory during the first parallel operation, and
the third processor accesses the third memory during the first parallel operation to perform a multiplication operation on the first element and one of the sampled second elements and writes the multiplication result to the fourth memory, based on the one sampled second element being stored in the third memory.

10. The electronic device of claim 9, wherein
the second processor accesses the second memory to sample the second element, and the third processor accesses the fourth memory to perform the cumulative summation operation, during the second parallel operation.

11. The electronic device of claim 1, wherein each memory of the at least one memory comprises a single port.

12. The electronic device of claim 1, wherein the hash function is a Secure Hash Algorithm KECCAK Extensible-output (SHAKE) function.

13. A method for generating an electronic signature, the method comprising:
storing a first element derived from a private key corresponding to a message;
generating a hash value by applying a hash function to a seed decoded from the private key;
performing an initial sampling to extract a second element from a sample matrix based on the hash value;
generating a multiplication matrix by repeatedly performing:
a first parallel operation that includes:
a first processor outputting the hash value; and
a second processor multiplying the first element and the second element to generate a multiplication result; and
a second parallel operation that includes:
the first processor performing sampling of additional second elements from the sample matrix using the output hash value; and
the second processor performing a cumulative summation operation on the multiplication result output for each row of the sample matrix;
performing a validity check based on the multiplication matrix; and
generating the electronic signature for the message based on, upon successful completion of the validity check.

14. The method of claim 13, further comprising:
writing the hash value to a first memory included in an electronic device; and
performing a sampling condition check based on the hash value.

15. The method of claim 14, wherein
the sampling of the additional second elements comprises sampling a corresponding one of the additional second elements from the hash value based on the success of the sampling condition check.

16. The method of claim 14, further comprising:
writing the second element to a second memory or a third memory included in the electronic device,
wherein the multiplying of the first element and the second element is performed based on an access to the second memory or the third memory, and
the cumulative summation operation is performed based on an access to a fourth memory included in the electronic device.

17. An electronic device for generating an electronic signature, comprising:
a plurality of processors including a first processor and a second processor; and
at least one memory connected to the processors to store a first element derived from a private key corresponding to a message,
wherein the electronic device is configured to:
generate a hash value by applying a hash function to a seed decoded from the private key;
sample a second element included in a sample matrix based on the hash value;
generate a multiplication matrix by repeatedly performing:
a first parallel operation that includes:
the first processor outputting the hash value; and
the second processor performing a multiplication operation of the first element and the second element to generate a multiplication result;
a second parallel operation that includes:
the first processor sampling additional second elements from the sample matrix; and
the second processor performing a cumulative summation operation on the multiplication result for each row of the sample matrix; and
a transition operation that includes writing the multiplication result or a result of the cumulative summation operation from one memory to another of the at least one memory;
perform a validity check on the multiplication matrix; and
generate the electronic signature for the message based on the first element, the sampled second elements and the multiplication matrix, upon successful completion of the validity check.

18. The electronic device of claim 17, wherein the least one memory comprises:
a first memory configured to store the hash value; and
a second memory and a third memory, each configured to store at least one of the first element, the sampled second elements, and the multiplication result or the summation result based on the cumulative summation operation.

19. The electronic device of claim 17, wherein the at least one memory comprises a first memory and a second memory, each configured to store at least one of the hash value, the first element, the sampled second elements, and the multiplication result or the summation result based on the cumulative summation operation.

20. The electronic device of claim 17, wherein each of the at least one memory comprises a single port.
